(19) United States
(12) Patent Application Publication
(10) Pub. No.: US 2006/0156844 A1
(43) Pub. Date: Jul. 20, 2006

(54) Ball screw mechanism

(75) Inventors: Tomofumi Yamashita, Kanagawa (JP); Daisaku Kawada, Kanagawa (JP); Shingo Saitou, Kanagawa (JP); Taikou Nawamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/302,249

(22) Filed: Dec. 14, 2005

(30) Foreign Application Priority Data
Dec. 14, 2004 (JP) P.2004-361334
Feb. 21, 2005 (JP) P.2005-043383
Feb. 21, 2005 (JP) P.2005-043384
Feb. 22, 2005 (JP) P.2005-045396
Jun. 22, 2005 (JP) P.2005-181370
Aug. 3, 2005 (JP) P.2005-225192

(51) Int. Cl. F16H 25/22

(52) U.S. Cl. 74/424.86

(57) ABSTRACT

Since a mounting member 11 has a cylindrical surface 11h to be engaged with a cylindrical hole 4d, it is possible to position a mounting member 11 and a nut 4 by only engaging the cylindrical surface 11h with the cylindrical hole 4d. Accordingly, it is possible to easily perform an assembly. In addition, when a force is applied to the mounting member 11 from the guide groove 1e of the case 1 in the rotational direction of the nut 4, the force is partially applied to the cylindrical hole 4d. Therefore, it is possible to reduce a load applied to screws 12 that fix the mounting member 11, and to use thinner screws.

The present application claims foreign priority under 35 USC 119 based on Japanese Patent Application Nos. 2005-225192 filed on Aug. 03, 2005, 2005-181370 filed on Jun. 22, 2005, 2005-045396 filed on Feb. 22, 2005, 2005-043384 filed on Feb. 21, 2005, 2005-043383 filed on Feb. 21, 2005 and 2004-361334 filed on Dec. 14, 2004, the contents of which are incorporated herein by reference in their entirety, and concurrently with the filing of this U.S. patent application.

### BACKGROUND OF THE INVENTION

The present invention relates to a ball screw mechanism that is assembled to general industrial machinery or is used for automobiles.

Recently, as labor saving is progressed in the automobile industry, a system that operates a transmission or a parking brake of the automobile by means of the force of the electrical motor instead of manually operating it. The electrical actuator to be used as described above uses a ball screw mechanism in order to efficiently convert the rotational movement transmitted from the electrical motor into the linear movement in the axial direction.

Meanwhile, when a screw shaft of the ball screw mechanism is rotated by the motor, there are many cases that a nut is not rotated with respect to a housing and can move only in the axial direction. In this case, for example, in the ball screw mechanism proposed in Patent Document 1, a tube retainer provided in the nut is engaged with a groove of the housing and thus the nut is not rotated.

Further, when a screw shaft of the ball screw mechanism is rotated by the motor, there are many cases that a nut is not rotated with respect to a housing and can move only in the axial direction. In this case, for example, by providing a protrusion to the nut and engaging the protrusion with a groove, which is formed in the housing so as to extend in the axial direction thereof, it is possible to prevent the rotation of the nut and to guide the nut. However, when the nut is provided with the protrusion, there has been a problem in that it is difficult to machine the nut and thus the manufacturing cost thereof is increased.

[Patent Document 1] U.S. Pat. No. 5,501,115

[Patent Document 2] JP-2004-100756

In the related art disclosed in Patent Document 1, since a flat surface of the tube retainer is engaged with a flat groove of the housing, it is necessary that the tube retainer and the housing be aligned. Furthermore, there is a problem that it is difficult to find thread holes to fasten bolts, whereby assemblability deteriorates. In addition, since a force, which is applied to the tube retainer in the rotational direction of the nut by the housing, is applied to the screws for mounting the tube retainer, it is necessary to use thick screws. For this reason, there is a problem that the structure is to be large.

Further, in the related art disclosed in Patent Document 1, the tube retainer serving as a snap ring moves in an axial direction together with a nut so as to be guided along a groove formed in the housing. If a gap between the tube retainer and the groove is small, there is a possibility that the operation fail occurs due to the interference between the tube retainer and the housing. Meanwhile, if a gap between the tube retainer and the groove is large, when a direction of a torque applied to the nut is reversed, the tube retainer collides against an opposite side surface of the groove. For this reason, there is a possibility that a noise occurs. However, when the accuracy of the parts is improved to manage the gap between the tube retainer and the groove in an optimum range, there is a problem that manufacturing cost is caused to be increased.

Still further, in the related art disclosed in Patent Document 1, since the tube retainer is mounted to the nut using screws, if assembly accuracy is bad, there is a possibility that the operation fail occurs due to the interference between the tube retainer and the housing. Furthermore, when the tube retainer is made of resin to reduce the weight thereof, there is a possibility that the life span of the ball screw mechanism deteriorates depending on use conditions due to the fact that heat resistance of a resin is inferior to that of a metal.

Still further, in the related art disclosed in Patent Document 1, since the tube retainer is mounted to the nut using screws, there is a case that the tube retainer may collide against and come in contact with the housing, for example, when the nut is rotated relative to the housing during power transmission. As a result, a problem may occur in that the screws are loosened. In order to cope with this problem, it is conceivable to prevent the loosening of the screws by coating a locking agent on the screws. However, a new problem may occur in that labor hour required for coating the locking agent increases or disassembly of the tube retainer during maintenance becomes difficult.

On the other hand, in Patent Document 2, the ball screw mechanism having the end caps is disclosed. However, in Patent Document 2, the end caps are made of synthetic resin, such as plastics, which may cause deformation or destruction due to a fastening force of the screws or a temperature change.

### SUMMARY OF THE INVENTION

The invention is made in consideration of the above-mentioned problems, and it is an advantage of the invention to provide a ball screw mechanism capable of securing reliability regardless of use conditions.

The invention is made in consideration of the above-mentioned problems, and it is an advantage of the invention to provide a ball screw mechanism capable of restraining the operation fail and the noise from occurring without an increase of the manufacturing cost.

The invention is made in consideration of the above-mentioned problems, and it is an advantage of the invention to provide a ball screw mechanism capable of securing reliability regardless of use conditions.

The invention is made in consideration of the above-mentioned problems, and it is an advantage of the invention to provide a ball screw mechanism capable of firmly fixing a circulating member to a nut.

According to a first aspect of the invention, a ball screw mechanism includes a housing that has a recess; a screw shaft that have a male thread groove on an outer peripheral surface thereof; a nut that is disposed so as to surround the screw shaft, has a female thread groove on an inner peripheral surface thereof, and has a cylindrical hole on an outer peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. In this case, the mounting member has a cylindrical surface to be engaged with the cylindrical hole, and extends outward in a radial direction of the nut and can be engaged with the recess of the housing in a state in which the mounting member is assembled with the nut.

According to the ball screw mechanism of a first aspect of the invention, since the mounting member has a cylindrical surface to be engaged with the cylindrical hole, it is possible to position a mounting member and a nut by only engaging the cylindrical surface with the cylindrical hole. Accordingly, it is possible to easily perform an assembly. In addition, when a force is applied to the mounting member from the housing in the rotational direction of the nut, the force is partially applied to the cylindrical hole. Therefore, it is possible to reduce a load applied to screws that fix the mounting member. Furthermore, since the mounting member extends outward in a radial direction of the nut and can be engaged with the recess of the housing in a state in which the mounting member is assembled with the nut, it is possible to prevent the nut from being rotated with respect to the housing, and it is not necessary to provide a snap ring, thereby providing a ball screw mechanism having simple structure. Moreover, if the ‘cylindrical hole’ is not completely cylindrical and has at least one part of a cylindrical surface, it is sufficient.

In addition, after the cylindrical surface is engaged with the cylindrical hole, it is necessary to align the assembly positions of the mounting member and the circulating member. However, when the mounting member is engaged with the cylindrical hole, if a structure for aligning the assembly positions is provided, it is possible to automatically align the assembly positions, whereby assemblability is improved.

According to a second aspect of the invention, a ball screw mechanism includes a housing that has a recess; a screw shaft that have a male thread groove on an outer peripheral surface thereof; a nut that is disposed so as to surround the screw shaft, and has a female thread groove on an inner peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. In this case, the mounting member includes a first engaging part that extends outward in a radial direction of the nut and can be engaged with one side surface of the recess of the housing, and a second engaging part that can be engaged with the other side surface of the recess of the housing, and the first engaging part and the second engaging part are mounted to the nut so as to move relative to the nut.

According to the ball screw mechanism of a second aspect of the invention, the mounting member includes a first engaging part that extends outward in a radial direction of the nut and can be engaged with one side surface of the recess of the housing, and a second engaging part that can be engaged with the other side surface of the recess of the housing, and the first engaging part and the second engaging part are mounted to the nut so as to move relative to the nut. Accordingly, the first engaging part and the second engaging part move relative to the nut by adjusting the dimension of the recess. For this reason, it is possible to set a gap between the first engaging part and one side surface of the groove, and a gap between the second engaging part and the other side surface of the groove to optimum values. As a result, it is possible to restrain the operation fail and the noise from occurring.

It is preferable that the first engaging part and the second engaging part be mounted to the nut so that the circulating member is interposed therebetween.

It is preferable that the first engaging part and the second engaging part be mounted to the nut by means of screws and be caulked in the vicinity of the screws after being mounted in order to prevent the separation of the screws.

According to a third aspect of the invention, a ball screw mechanism includes a housing that has a recess; a screw shaft that: have a male thread groove on an outer peripheral surface thereof; a nut that is disposed so as to surround the screw shaft and has a female thread groove on an inner peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. In this case, the nut is integrally formed with an engaging portion, which extends outward in a radial direction and can be engaged with the recess of the housing.

According to the ball screw mechanism of a third aspect of the invention, the nut is integrally formed with the engaging portion, which extends outward in the radial direction and can be engaged with the recess. Accordingly, the rotation of the nut is prevented by engaging the engaging portion with the recess. Furthermore, since the engaging portion is accurately formed with respect to the nut, the relative positional relation between the engaging portion and the housing is defined with high accuracy. For this reason, it is possible to restrain from the operation fail. In addition, since the engaging portion is made of the same material (for example, metal) as that of the nut; it is possible to secure the life span regardless of use conditions.

If the engaging portion has a pair of engaging surfaces facing each other in a circumferential direction of the nut and a predetermined gap is formed between at least one of the engaging surfaces and a guide surface of the recess of the housing, since the engaging surfaces are likely smoothly slid along the guide surface, it is preferable. In addition, face each other in the circumferential direction means that both of the engaging surfaces do not have to be necessarily orthogonal to the circumferential direction, and at least one thereof may incline with respect to the circumferential direction.

It is preferable that the ball screw mechanism further include a buffer member for buffering collision occurring between the nut relatively moving in an axial direction and the housing.

According to a forth aspect of the invention, a ball screw mechanism includes a housing; a screw shaft that have a male thread groove on an outer peripheral surface thereof; a nut that is disposed so as to surround the screw shaft and has a female thread groove on an inner peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. In this case, the nut has a locking part, which includes a narrow portion having a first width W1 and a wide portion that is positioned on the outside of the narrow portion in the radial direction and has a second width W2 in a cross-section orthogonal to an axis of the nut, on the periphery of the nut. Furthermore, the mounting member has a locking groove, which includes a narrow portion having a third width W3 and a wide portion that is positioned on the outside of the narrow portion in the radial direction and has a fourth width W4 in a cross-section orthogonal to an axis of the mounting member, in a state in which the mounting member is mounted to the nut. In addition, the mounting member is mounted to the nut by the engagement between the locking part and the locking groove, and an expression W1≦W3<W2≦W4 is satisfied.

According to the ball screw mechanism of a forth aspect of the invention, the nut has a locking part, which includes a narrow portion having a first width W1 and a wide portion that is positioned on the outside of the narrow portion in the radial direction and has a second width W2 in a cross-section orthogonal to an axis of the nut, on the periphery of the nut. Furthermore, the mounting member has a locking groove, which includes a narrow portion having a third width W3 and a wide portion that is positioned on the outside of the narrow portion in the radial direction and has a fourth width W4 in a cross-section orthogonal to an axis of the mounting member, in a state in which the mounting member is mounted to the nut. In addition, the mounting member is mounted to the nut by the engagement between the locking part and the locking groove, and an expression W1≦W3<W2≦W4 is satisfied. Accordingly, the outward separation of the mounting member from the nut in the radial direction is prevented without using the screws. Moreover, even when a force is applied to the circulating member in the radial direction of the nut, the locking part can bear the force.

It is preferable that movement of the mounting member relative to the nut in an axial direction be limited by a fastener.

It is preferable that movement of the mounting member relative to the nut in an axial direction be limited by caulking.

According to a fifth aspect of the invention, A ball screw mechanism includes a housing; a screw shaft that have a male thread groove on an outer peripheral surface thereof; a nut that is disposed so as to surround the screw shaft and has a female thread groove on an inner peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. A periphery of the nut is formed with flange surfaces facing each other in a circumferential direction, and at least a portion of the mounting member is disposed between the housing and the flange surfaces.

According to a sixth aspect of the invention, a ball screw mechanism includes a housing; a screw shaft that have a male thread groove on an outer peripheral surface thereof; a nut that is disposed so as to surround the screw shaft and has a female thread groove on an inner peripheral surface thereof; a plurality of balls that is disposed so as to roll along a raceway formed between the thread grooves facing each other; a circulating member that is mounted to the nut so as to return the balls from one end of the raceway to the other end thereof; and a mounting member that fixes the circulating member to the nut. The circulating member is made of a resin in which metal barrels are disposed around at least the screws.

According to the ball screw mechanism of the fifth aspect of the invention, a periphery of the nut is formed with flange surfaces facing each other in a circumferential direction, and at least a portion of the mounting member is disposed between the housing and the flange surface. Thus, even when the housing and the mounting member collide with each other during power transmission, the resulting impact force is received by the flange surfaces. Therefore, the impact force can be kept from being transmitted to screws, etc., that fix the mounting member, so that loosening of the screws can be prevented. In addition, the “facing each other in a circumferential direction” means that both the flange surfaces are not necessarily orthogonal to the circumferential direction, and at least one of the flange surfaces may be inclined with respect to the circumferential direction.

It is preferable that the mounting member be mounted to the nut by screws.

When the mounting member is made of a resin in which metal barrels are disposed around at least the screws, the fastening force of the screws can be received by the metal barrels, and thus deformation of the mounting member can be suppressed.

According to the ball screw mechanism of the sixth aspect of the invention, the circulating member is made of a resin in which metal barrels are disposed around at least the screws. Thus, the fastening force of the screws can be received by the metal barrels, and thus deformation of the mounting member can be suppressed.

### BRIEF DESCRIPTION OF THE DRAWINGS

FIG. 1 is a cross-sectional view showing a cylinder device in which a ball screw mechanism of a first embodiment is assembled.

FIG. 2 is a cross-sectional view taken along line II-II of FIG. 1 as seen in a direction indicated by arrows.

FIG. 3A is a bottom view of a mounting member, FIG. 3B is a side view thereof, and FIG. 3C is a top view thereof.

FIG. 4 is a perspective view showing a state in which a tube and a mounting member are exploded from the nut.

FIG. 5 is a view showing the operation of the cylinder device.

FIG. 6 is a view showing the operation of the cylinder device.

FIG. 7 is a cross-sectional view showing a cylinder device in which a ball screw mechanism of a second embodiment is assembled.

FIG. 8 is a cross-sectional view taken along line II-II of FIG. 7 as seen in a direction indicated by arrows.

FIG. 9 is a cross-sectional view taken along line III-III of FIG. 7 as seen in a direction indicated by arrows.

FIG. 10 is a top view showing a mounting member 111 in a mounting state.

FIG. 11 is a view showing the operation of the cylinder device.

FIG. 12 is a view showing the operation of the cylinder device.

FIG. 13 is a cross-sectional view showing a cylinder device in which a ball screw mechanism of a third embodiment is assembled.

FIG. 14 is a cross-sectional view taken along line II-II of FIG. 13 as seen in a direction indicated by arrows.

FIGS. 15A and 15B are views illustrating the operation of the cylinder device.

FIG. 16 is a top view of a ball screw mechanism of a forth embodiment.

FIG. 17 is a view showing a structure shown in FIG. 16 as seen in a direction indicated by an arrow II.

FIG. 18 is a cross-sectional view taken along line III-III of FIG. 16 as seen in a direction indicated by arrows.

FIG. 19 is an exploded perspective view showing the ball screw mechanism of the forth embodiment.

FIG. 20 is a top plan view of a ball screw mechanism of a fifth embodiment.

FIG. 21 is a view showing a structure shown in FIG. 20 as seen in a direction indicated by an arrow VI.

FIG. 22 is a cross-sectional view taken along line VII-VII of FIG. 20 as seen in a direction indicated by arrows.

FIG. 23 is a top plan view of a ball screw mechanism of a sixth embodiment.

FIG. 24 is a view showing a structure of FIG. 23 is cut along a line II-II and seen in a direction indicated by arrows.

FIG. 25 is a view when the structure of FIG. 23 is cut along a line III-III and seen in a direction indicated by arrows.

FIG. 26 is a cross-sectional view, similar to FIG. 24, of a ball screw mechanism according to a seventh embodiment.

FIG. 27 is an axial sectional view of a ball screw mechanism according to an eighth embodiment.

FIG. 28 is a view showing a one end cap 414 as seen from the axial outside.

FIG. 29 is a view when the end cap 414 of FIG. 28 is cut along a line VII-VII and seen in a direction indicated by arrows.

FIG. 30 is a view showing the end cap 414 as seen from the axial inside.

### DETAILED DESCRIPTION OF THE PREFERRED EMBODIMENTS

### First Embodiment

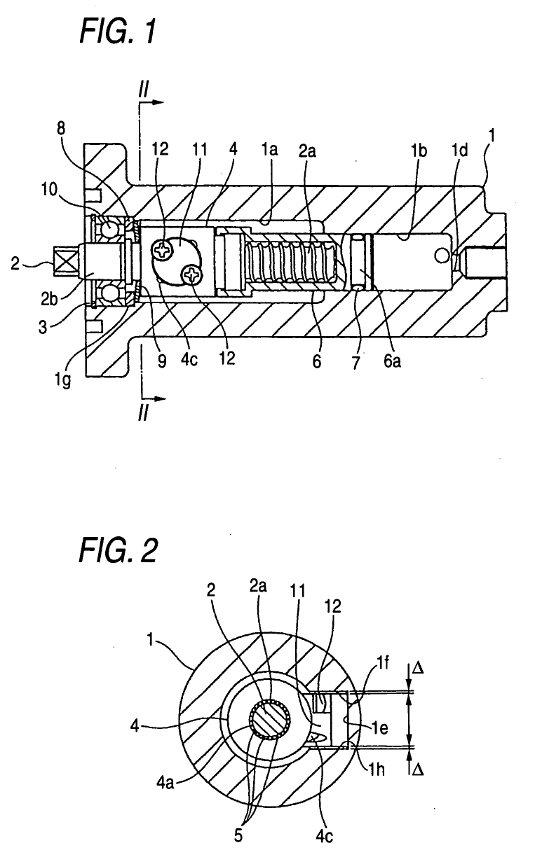

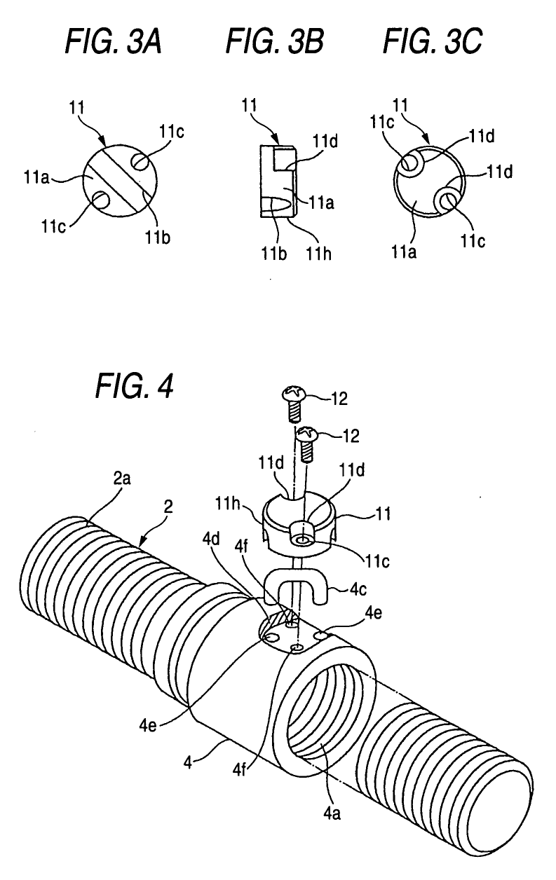

Hereinafter, a preferred embodiment of the invention will be described with reference to accompanying drawings. FIG. 1 is a cross-sectional view showing a cylinder device in which a ball screw mechanism of a first embodiment is assembled. FIG. 2 is a cross-sectional view taken along line II-II of FIG. 1 as seen in a direction indicated by arrows. FIG. 3A is a bottom view of a mounting member, FIG. 3B is a side view thereof, and FIG. 3C is a top view thereof. FIG. 4 is a perspective view showing a state in which a tube and a mounting member are exploded from the nut.

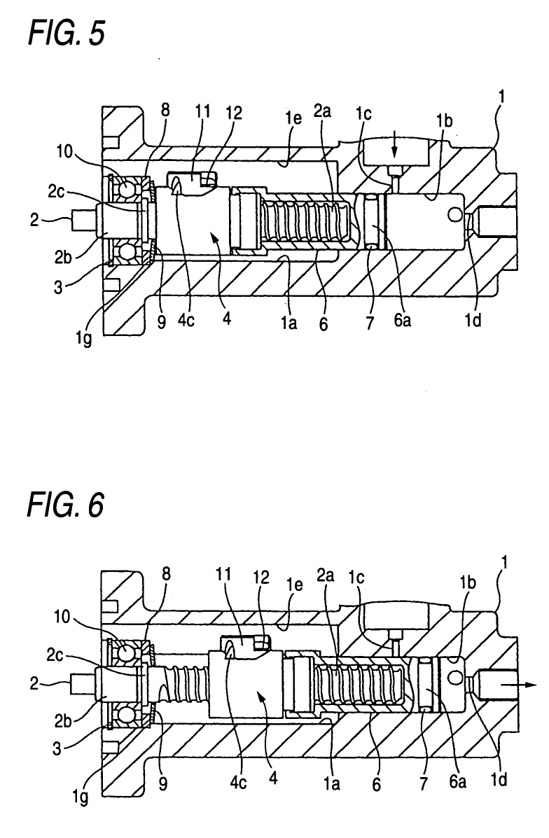

In the cylinder device shown in FIG. 1, a cylindrical case 1 (also called as a housing) has a cavity 1a for receiving a ball screw mechanism in the inside thereof, a cylinder portion 1b having a constant diameter, a fluid inlet 1c (FIGS. 5 and 6) communicating with the cylinder portion 1b, and a fluid outlet 1d. In addition, the fluid inlet 1c may be provided with a check valve for allowing only an inflow of the fluid, and the fluid outlet 1d may be provided with a check valve for allowing only an outflow of the fluid. A guide groove (recess) 1e extending in an axial direction is formed on the inner periphery of the case 1.

A screw shaft 2 of which one end (left end in FIG. 1) is coupled with a motor (not shown) disposed outside of the case 1 is provided in the cavity 1a of the case 1. A male thread groove 2a and a cylindrical shaft portion 2b, and a flange portion 2c therebetween are formed on the outer periphery of the screw shaft 2. An inner race of a bearing 10 is fitted to the outer periphery of the cylindrical shaft portion 2b, and the internal end (right end in FIG. 1) of the bearing comes in contact with the flange portion 2c. Furthermore, an outer end (left end in FIG. 1) of an outer race of the bearing 10 comes in contact with a snap ring 3 implanted into the cavity 1a of the case 1. Accordingly, even though the screw shaft 2 is supported by the bearing 10 so as to be rotatable with respect to the case 1. The screw shaft cannot move in an axial direction thereof.

In addition, a spacer 8 is interposed between the inner end (right end in FIG. 1) of the outer race of the bearing 10 and a stepped portion 1g of the case 1, and a leaf spring (buffer member) 9 is disposed adjacent to the spacer 8. The bearing 10 and the spacer 8 are mounted to the case 1 by the snap ring 3.

Meanwhile, a cylindrical nut 4, which is supported so as to be movable with respect to the case 1 only in the axial direction as described below, is disposed to surround the screw shaft 2, and has a female thread groove 4a on the inner periphery thereof (see FIG. 2). A plurality of balls 5 is disposed so as to be able to roll within a spiral raceway formed between the thread grooves 2a and 4a facing each other. The screw shaft 2, the nut 4, and the balls 5 constitute the ball screw mechanism.

A tube 4c, which is formed by bending a circular tube in a U shape, is mounted on the outer periphery of the nut 4. The tube 4c serving as a circulating member is fixed to the nut 4 by fixing a mounting member 11 to the nut 4 by means of screws 12, and has a function to return the balls 5 from one end of the spiral raceway formed between the both thread grooves 2a and 4a to the other end thereof during the operation of the ball screw mechanism.

As shown in FIG. 3, the mounting member 11 includes a cylindrical main body 11a, and a cylindrical (may be gabled) engaging surface 11b is formed in the middle on the lower surface of the cylindrical body. The cylindrical engaging surface 11b can be positioned by being engaged with the outer periphery of the tube 4c. In addition, the mounting member has two through holes 11c, into which screws 12 are inserted, parallel to the axial direction. A counter sunk portion lid is formed on the upper side of each of the through holes 11c (see FIG. 3C). Accordingly, since the engaging surface 11b and the counter sunk portion 11d are provided on the outer peripheral surface (cylindrical surface) 11h of the main body 11a, the mounting member is formed in the shape of a partially notched cylinder (see FIG. 3B).

Meanwhile, as shown in FIG. 4, a cylindrical hole 4d, which has the substantially same inner diameter as the outer diameter of the mounting member 11, is formed on the outer periphery of the nut 4, and two tube mounting holes 4e and two thread holes 4f are formed through the bottom surface of the cylindrical hole. At the time of the assembly, both ends of the tube 4c are inserted into the tube mounting holes 4e and the mounting member 11 is approached from the outside in the radial direction of the nut so that the outer peripheral surface 11h is fitted into the cylindrical hole 4d. In this case, even though the mounting member 11 is not aligned with the assembly position, if the mounting member is rotated in the cylindrical hole 4d so that the outer periphery of the tube 4c is engaged with the cylindrical engaging surface 11b on the lower surface of the mounting member 11, it is possible to easily align the mounting member with the assembly position. That is, a structure for aligning the mounting member with the assembly position includes the outer periphery of the tube 4c and the engaging surface 11b.

If the two screws 12 are inserted into the through holes 11c, respectively, in a state in which the mounting member 11 is aligned with the assembly position, the two screws can be fastened into the thread holes 4f and thus the assemblability is improved. When the screws 12 are fastened, the mounting member 11 can hold the tube 4c at a predetermined position on the nut 4.

If each of gaps Δ between the mounting member 11 and the side surfaces of the guide groove 1e is, for example, about 0.3±0.1 mm, interference and noise may be restrained during the time when the mounting member 11 moves along the guide groove 1e in the axial direction. When the mounting member 11 is made of metal, it is preferable that the mounting member be caulked in the vicinity of the heads of the screws 12 so as to be plastically deformed. Meanwhile, the mounting member 11 may be made of a resin material (also including metal covered with a resin).

A hollow piston member 6 having one end closed is fixed at the right end of the nut 4 in FIG. 1. The piston member 6 is configured so that the screw shaft 2 can be retracted thereinto and extracted therefrom. The outer peripheral surface of the piston member 6 is closely fitted to the inner peripheral surface of the cylinder portion 1b of the case 1, and then can be slid the inner peripheral surface of the cylinder portion 1b. An O-ring is disposed in a peripheral groove 6a formed on the piston member 6 in the vicinity of the right end thereof, and functions to prevent the fluid filled in the cylinder portion 1b from leaking through a gap between the piston member 6 and the cylinder portion 1b to the cavity 1a.

Each of FIGS. 5 and 6 is a view showing the operation of the cylinder device. The cylinder device can be used to push brake fluid at the time of braking of a vehicle.

Hereinafter, the operation of the first embodiment will be described. When the screw shaft 2 is driven to be rotated in one direction by a motor (not shown), the rotational movement of the screw shaft is efficiently converted into the linear movement of the nut 4 in the axial direction by the balls 3 that roll within the raceway and circulates from one end of the raceway to the other end thereof through the tube 4c so that the piston member 6 coupled with the nut can be transferred in the axial direction as shown in FIG. 5. The rotational movement of the screw shaft 2 in one direction causes the nut 4 to be rotated in the same direction 2 as the screw shaft 2. However, since the outer peripheral surface of the mounting member 11, and the side surface 1h of the guide groove 1e, which face each other in the rotational direction, come in contact with each other, the rotation of the nut 4 is prevented. Furthermore, since the mounting member 11 is slid along the side surface 1h, the nut 4 moves in the axial direction thereof while being guided. In this case, the external fluid is flown from the fluid inlet 1c of the case 1 to the inside of the cylinder portion 1b. In addition, if the nut 4 overruns, first, the nut comes in contact with the leaf spring 9 and then elastically deforms the leaf spring. Accordingly, the collision energy of the nut 4 is absorbed due to the buffer function of the leaf spring, and thus it is possible to restrain the nut 4 and the case 1 from being damaged.

When the screw shaft 2 is rotated in the reverse direction by the motor (not shown) after the nut 4 moves to the end of the stroke, the rotational movement of the screw shaft is efficiently converted into the linear movement of the nut 4 in the axial direction so that the piston member 6 coupled with the nut is transferred to the right side in the axial direction as shown in FIG. 6, similar to the above. Similarly, the rotational movement of the screw shaft 2 in the reverse direction causes the nut 4 to be rotated in the same direction as the screw shaft 2. However, since the outer peripheral surface of the mounting member 11 and the side surface if of the guide groove 1e, which face each other in the rotational direction, come in contact with each other, the rotation of the nut 4 is prevented. Furthermore, since the mounting member 11 is slid along the side surface 1f, the nut 4 moves in the axial direction thereof while being guided. In this case, the fluid in the cylinder portion 1b can be discharged from the fluid inlet 1c of the case 1 to the outside of the cylinder portion 1b. Accordingly, it is possible to operate the brake apparatus by connecting a wheel cylinder of the brake apparatus with the fluid inlet 1d.

According to the first embodiment, since the mounting member 11 has the cylindrical surface 11h to be engaged with the cylindrical hole 4d, it is possible to position the mounting member 11 and the nut 4 by only engaging the cylindrical surface 11h with the cylindrical hole 4d. Accordingly, it is possible to easily perform an assembly. In addition, when a force is applied to the mounting member 11 from the guide groove 1e of the case 1 in the rotational direction of the nut 4, the force is partially applied to the cylindrical hole 4d. Therefore, it is possible to reduce a load applied to the screws 12 that fix the mounting member 11, and to use thinner screws.

### Second Embodiment

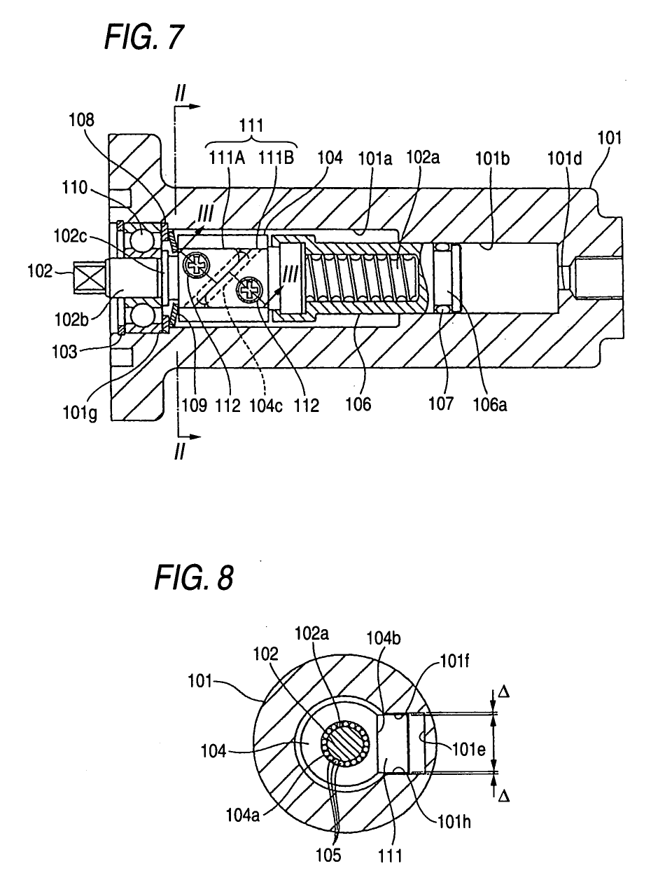

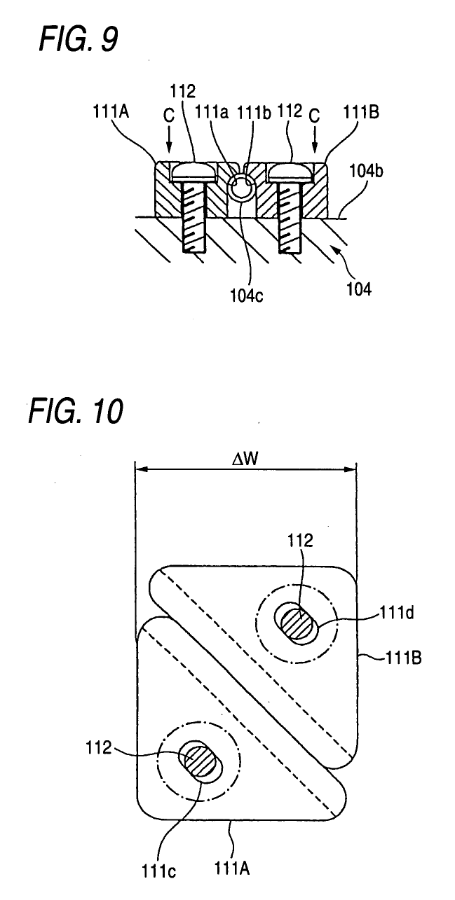

Hereinafter, a preferred embodiment of the invention will be described with reference to accompanying drawings. FIG. 7 is a cross-sectional view showing a cylinder device in which a ball screw mechanism of a second embodiment is assembled. FIG. 8 is a cross-sectional view taken along line II-II of FIG. 7 as seen in a direction indicated by arrows. FIG. 9 is cross-sectional view taken along line III-III of FIG. 7 as seen in a direction indicated by arrows. FIG. 10 is a top view showing a mounting member in a mounting state.

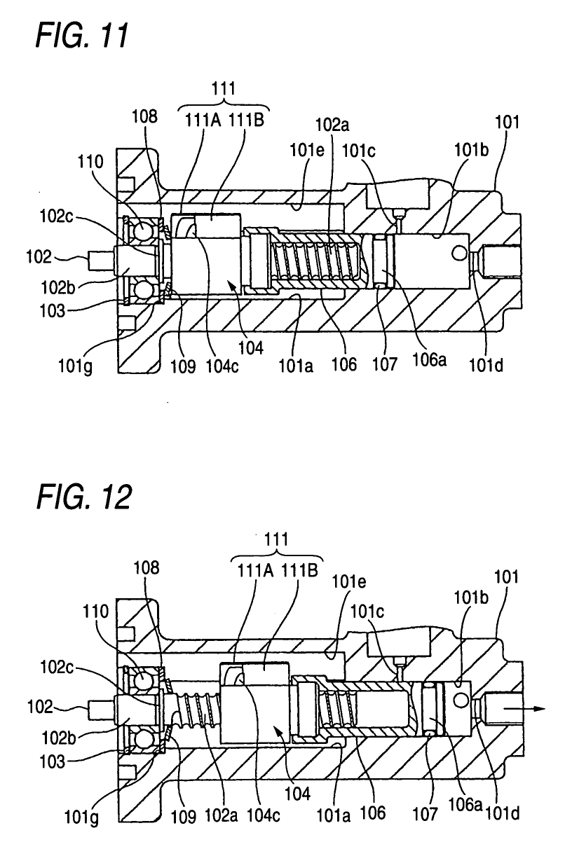

In the cylinder device shown in FIG. 7, a cylindrical case 101 (also called as a housing) has a cavity 101a for receiving a ball screw mechanism in the inside thereof, a cylinder portion 101b having a constant diameter, a fluid inlet 101c (FIGS. 11 and 12) communicating with the cylinder portion 101b, and a fluid outlet 101d. In addition, the fluid inlet 101c may be provided with a check valve for allowing only an inflow of the fluid, and the fluid outlet 101d may be provided with a check valve for allowing only an outflow of the fluid. A guide groove (recess) 101e extending in an axial direction is formed on the inner periphery of the case 101.

A screw shaft 102 of which one end (left end in FIG. 7) is coupled with a motor (not shown) disposed outside of the case 101 is provided in the cavity 101a of the case 101. A male thread groove 102a and a cylindrical shaft portion 102b, and a flange portion 102c therebetween are formed on the outer periphery of the screw shaft 102. An inner race of a bearing 110 is fitted to the outer periphery of the cylindrical shaft portion 102b, and the internal end (right end in FIG. 7) of the bearing comes in contact with the flange portion 102c. Furthermore, an outer end (left end in FIG. 7) of an outer race of the bearing 110 comes in contact with a snap ring 103 implanted into the cavity 101a of the case 101. Accordingly, even though the screw shaft 102 is supported by the bearing 110 so as to be rotatable with respect to the case 101. The screw shaft cannot move in an axial direction thereof.

In addition, a leaf spring (buffer member) 109 and a spacer 108 to be integrally formed are interposed between the inner end (right end in FIG. 7) of the outer race of the bearing 110 and a stepped portion 101g of the case 101. That is, the bearing 110 and the spacer 108 are mounted to the case 101 by the snap ring 103.

Meanwhile, a cylindrical nut 104, which is supported so as to be movable with respect to the case 101 only in the axial direction as described below, is disposed to surround the screw shaft 102, and has a female thread groove 104a on the inner periphery thereof (see FIG. 8). A plurality of balls 105 is disposed so as to be able to roll within a spiral raceway formed between the thread grooves 102a and 104a facing each other. The screw shaft 102, the nut 104, and the balls 105 constitute the ball screw mechanism.

A flat surface 104b is formed on the outer periphery of the nut 104. The tube 104c serving as a circulating member is mounted on the flat surface 104b. The tube 104c is fixed to the nut 104 by fixing a mounting member 111 to the nut 104 by means of screws 112, and has a function to return the balls 105 from one end of the spiral raceway formed between the both thread grooves 102a and 104a to the other end thereof during the operation of the ball screw mechanism.

The mounting member 111 includes two triangular prism-shaped parts 111A and 111B. As shown in FIG. 9, the part 111A and 111B have engaging surfaces 111a and 111b, respectively, which are modeled after the outer peripheral surface of the tube 104c. When the parts 111A and 111B are assembled to the nut 104, the outer peripheral surface of the tube 104c is interposed between the engaging surfaces 111a and 111b from the both sides thereof. In addition of as shown in FIG. 10, the parts 111A and 111B have long holes 111c and 111d through which the screws 112 are inserted, respectively. Here, the part 111A configures a first engaging part, and the part 111B configures a second engaging part.

As shown in FIG. 7, the mounting member 111 can be inserted into and engaged with a guide groove 101e, which is formed on the inner peripheral surface of the cavity 101a of the case 101 along the axial direction so as to have a rectangular cross-section.

A hollow piston member 106 having one end closed is fixed at the right end of the nut 104 in FIG. 7. The piston member 106 is configured so that the screw shaft 102 can be retracted thereinto and extracted therefrom. The outer peripheral surface of the piston member 106 is closely fitted to the inner peripheral surface of the cylinder portion 101b of the case 101, and then can be slid the inner peripheral surface of the cylinder portion 101b. An O-ring 107 is disposed in a peripheral groove 106a formed on the piston member 106 in the vicinity of the right end thereof, and functions to prevent the fluid filled in the cylinder portion 101b from leaking through a gap between the piston member 106 and the cylinder portion 101b to the cavity 101a.

If each of gaps Δ between the mounting member 111 and the side surfaces of the guide groove 101e is, for example, about 0.3±0.1 mm, interference and noise may be restrained during the time when the mounting member 111 moves along the guide groove 101e in the axial direction. However, if the gap Δ is managed only by managing the dimension of the parts, there is a problem that manufacturing cost is caused to be increased.

Meanwhile, in the second embodiment, when the parts 111A and 111B are assembled to the nut 104, the parts move relative to each other to some extent. More specifically, as shown in FIG. 10, since the parts 111A and 111B can move relative to the nut 104 in the range of the long holes 111c and 111d, it is possible to set the width ΔW of the mounting member 111 to any value by adjusting the positions of the parts. That is, a dimension of the guide groove 101e of the case, which is required to the assembly, is measured, and the width ΔW of the mounting member 111, which can be used to set an optimum gap Δ, is obtained on the basis of the measured value. After that, the parts 111A and 111B are properly positioned on the nut 104, and then are fixed by means of screws 112. It is possible to obtain the optimum gap Δ by assembling the nut 104, to which the mounting member 111 is mounted, to the case 101.

Furthermore, when the parts 111A and 111B are made of metal, it is preferable that the parts be caulked in the vicinity (for example, C in FIG. 9) of the heads of the screws 112 so as to be plastically deformed in order to prevent the screws from being loosening. In addition, since the long holes 111c and 111d are formed to extend parallel to the engaging surfaces 111a and 111b, the parts 111A and 111B can retain the tube 104 even in the case in which the parts 111A and 111B move relative to the nut 104.

Each of FIGS. 11 and 12 is a view showing the operation of the cylinder device. The cylinder device can be used to push brake fluid at the time of braking of a vehicle.

Hereinafter, the operation of the second embodiment will be described. When the screw shaft 102 is driven to be rotated in one direction by a motor (not shown), the rotational movement of the screw shaft is efficiently converted into the linear movement of the nut 104 in the axial direction by the balls 105 that roll within the raceway and circulates from one end of the raceway to the other end thereof through the tube 104c so that the piston member 106 coupled with the nut can be transferred to the left side in the axial direction as shown in FIG. 11. The rotational movement of the screw shaft 102 in one direction causes the nut 104 to be rotated in the same direction as the screw shaft 102. However, since a side surface of the part 111A of the mounting member 111, and one side surface 101f of the guide groove 101e, which face each other in the rotational direction, come in contact with each other, the rotation of the nut 104 is prevented. Furthermore, since the side surface of the part 111A of the mounting member 111 is slid along the one side surface 101f, the nut 104 moves in the axial direction thereof while being guided. In this case, the external fluid is flown from the fluid inlet 101c of the case 101 to the inside of the cylinder portion 101b. In addition, if the nut 104 overruns, first, the nut comes in contact with the leaf spring 109 and then elastically deforms the leaf spring. Accordingly, the collision energy of the nut 104 is absorbed due to the buffer function of the leaf spring, and thus it is possible to restrain the nut 104 and the case 101 from being damaged.

When the screw shaft 102 is rotated in the reverse direction by the motor (not shown) after the nut 104 moves to the end of the stroke, the rotational movement of the screw shaft is efficiently converted into the linear movement of the nut 104 in the axial direction so that the piston member 106 coupled with the nut is transferred to the right side in the axial direction as shown in FIG. 12, similar to the above. Similarly, the rotational movement of the screw shaft 102 in the reverse direction causes the nut 104 to be rotated in the same direction as the screw shaft 102. However, since a side surface of the part 111B of the mounting member 111, and the other side surface 101h of the guide groove 101e, which face each other in the rotational direction, come in contact with each other, the rotation of the nut 104 is prevented. Furthermore, since the side surface of the part 111B of the mounting member 111 is slid along the other side surface 101h, the nut 104 moves in the axial direction thereof while being guided. In this case, the fluid in the cylinder portion 101b can be discharged from the fluid inlet 101c of the case 101 to the outside of the cylinder portion 101b. Accordingly, it is possible to operate the brake apparatus by connecting a wheel cylinder of the brake apparatus with the fluid inlet 101c.

According to the second embodiment, since the mounting member 111 fixed to the nut 104 is engaged with the guide groove 101e, it is possible to prevent the nut 104 from being rotated. Furthermore, since a gap Δ between the mounting member and the guide groove 101e is set to any value by the movement of the parts 111A and 111B relative to the nut, it is possible to restrain the operation fail and the noise from occurring. Accordingly, the ball screw mechanism can be smoothly operated.

### Third Embodiment

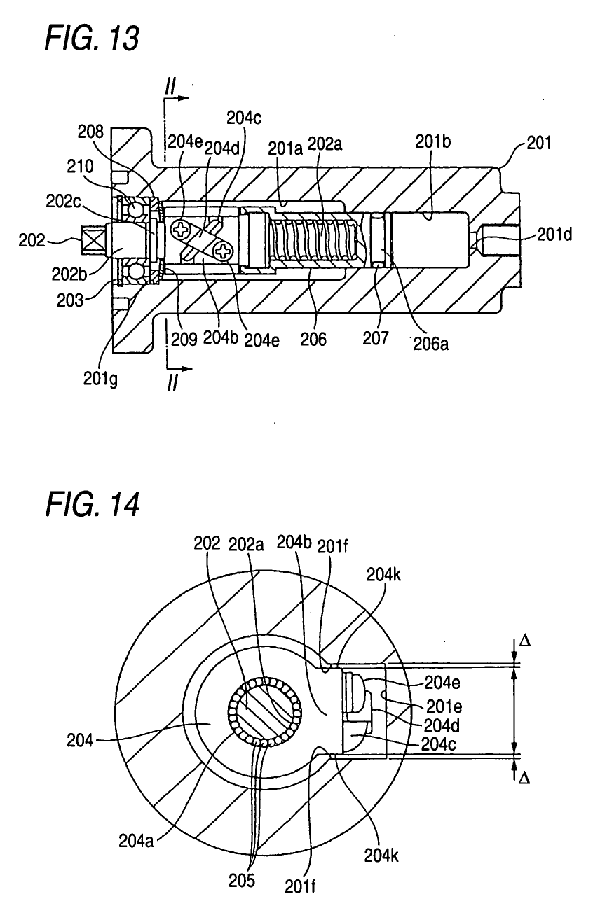

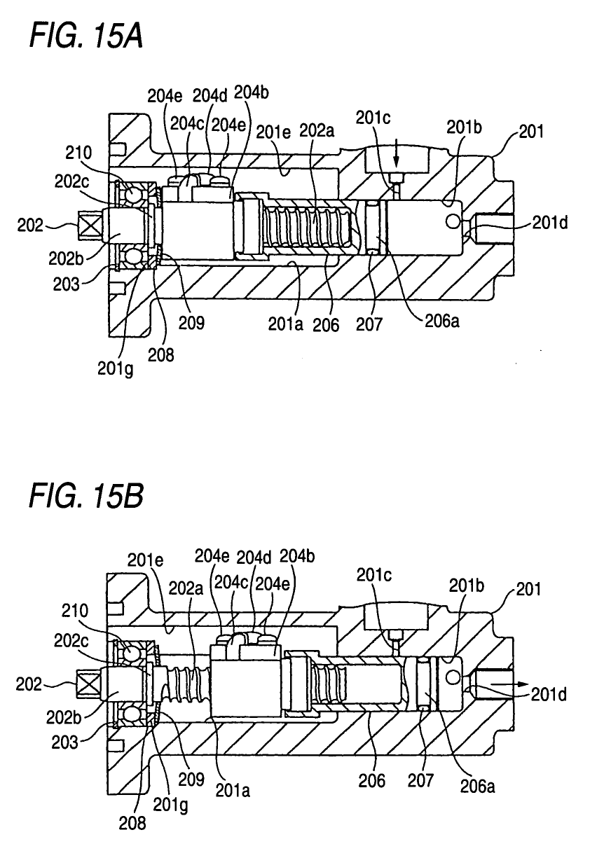

Hereinafter, a preferred embodiment of the invention will be described with reference to accompanying drawings. FIG. 13 is a cross-sectional view showing a cylinder device in which a ball screw mechanism of a third embodiment is assembled. FIG. 14 is a cross-sectional view taken along line II-II of FIG. 13 as seen in a direction indicated by arrows. FIG. 15 is a view illustrating the operation of the cylinder device. The cylinder device can be used to push brake fluid at the time of braking of a vehicle.

In the cylinder device shown in FIG. 13, a cylindrical case 201 (also called as a housing) has a cavity 201a for receiving a ball screw mechanism in the inside thereof, a cylinder portion 201b having a constant diameter, a fluid inlet 201c (FIG. 15) communicating with the cylinder portion 201b, and a fluid outlet 201d. In addition, the fluid inlet 201c may be provided with a check valve for allowing only an inflow of the fluid, and the fluid outlet 201d may be provided with a check valve for allowing only an outflow of the fluid.

A screw shaft 202 of which one end (left end in FIG. 13) is coupled with a motor (not shown) disposed outside of the case 201 is provided in the cavity 201a of the case 201. A male thread groove 202a and a cylindrical shaft portion 202b, and a flange portion 202c therebetween are formed on the outer periphery of the screw shaft 202. An inner race of a bearing 210 is fitted to the outer periphery of the cylindrical shaft portion 202b, and the internal end (right end in FIG. 13) of the bearing comes in contact with the flange portion 202c. Furthermore, an outer end (left end in FIG. 13) of an outer race of the bearing 210 comes in contact with a snap ring 203 implanted into the cavity 201a of the case 201. Accordingly, even though the screw shaft 202 is supported by the bearing 210 so as to be rotatable with respect to the case 201. The screw shaft cannot move in an axial direction thereof.

In addition, a spacer 208 and a leaf spring (buffer member) 209 are interposed between the inner end (right end in FIG. 13) of the outer race of the bearing 210 and a stepped portion 201g of the case 201, that is, the bearing 210, the spacer 208 and the leaf spring 209 are mounted to the case 201 by the snap ring 203.

Meanwhile, a cylindrical nut 204, which is supported so as to be only rotatable with respect to the case 201 as described below, is disposed to surround the screw shaft 202, and has a female thread groove 204a on the inner periphery thereof (see FIG. 14). A plurality of balls 205 is disposed so as to be able to roll within a spiral raceway formed between the thread grooves 202a and 204a facing each other. The screw shaft 202, the nut 204, and the balls 205 constitute the ball screw mechanism.

As shown in FIG. 14, a rectangular plate-shaped portion 204b is integrally formed on the outer periphery of the nut 204 so as to extend in a radial direction. The rectangular plate-shaped portion 204b serving as an engaging portion can be inserted into and engaged with a guide groove 201e, which is formed on the inner peripheral surface of the cavity 201a of the case 201 along the axial direction so as to have a rectangular cross-section. Predetermined gaps Δ is formed between side surfaces (engaging surfaces) 204k and 204k of the rectangular plate-shaped portion 204b, and side surfaces (guide surfaces) 201f and 201f of guide groove 201e facing each other, respectively. Each of the predetermined gaps A is preferably, for example, about 0.3±0.1 mm.

The rectangular plate-shaped portion 204b is provided with a tube 204c serving as a circulating member on the outermost surface thereof in the plan view. The tube 204c is fixed to the nut 204 by fixing a bracket 204d to the nut 204 by means of screws 204e, and has a function to return the balls 205 from one end of the spiral raceway formed between the both thread grooves 202a and 204a to the other end thereof during the operation of the ball screw mechanism.

A hollow piston member 206 having one end closed is fixed at the right end of the nut 204 in FIG. 13. The piston member 206 is configured so that the screw shaft 202 can be retracted thereinto and extracted therefrom. The outer peripheral surface of the piston member 206 is closely fitted to the inner peripheral surface of the cylinder portion 201b of the case 201, and then can be slid the inner peripheral surface of the cylinder portion 201b. An O-ring 207 is disposed in a peripheral groove 206a formed on the piston member 206 in the vicinity of the right end thereof, and functions to prevent the fluid filled in the cylinder portion 201b from leaking through a gap between the piston member 206 and the cylinder portion 201b to the cavity 201a.

Hereinafter, the operation of the third embodiment will be described. When the screw shaft 202 is driven to be rotated in one direction by a motor (not shown), the rotational movement of the screw shaft is efficiently converted into the linear movement of the nut 204 in the axial direction by the balls 205 that roll within the raceway and circulates from one end of the raceway to the other end thereof through the tube 204c so that the piston member 206 coupled with the nut can be transferred in the axial direction as shown in FIG. 15A. The rotational movement of the screw shaft 202 in one direction causes the nut 204 to be rotated in the same direction as the screw shaft 202. However, since the side surface 204k of the rectangular plate-shaped portion 204b, and the side surface 201f of the guide groove 201e, which face each other, come in contact with each other, the rotation of the nut 204 is prevented. Furthermore, since the side surface 204k is slid along the side surface 201f, the nut 204 moves in the axial direction thereof while being guided. In this case, the external fluid is flown from the fluid inlet 201c of the case 201 to the inside of the cylinder portion 201b. In addition, if the nut 204 overruns, first, the nut comes in contact with the leaf spring 209 and then elastically deforms the leaf spring. Accordingly, the collision energy of the nut 204 is absorbed due to the buffer function of the leaf spring, and thus it is possible to restrain the nut 204 and the case 201 from being damaged.

When the screw shaft 202 is rotated in the reverse direction by the motor (not shown) after the nut 204 moves to the end of the stroke, the rotational movement of the screw shaft is efficiently converted into the linear movement of the nut 204 in the axial direction so that the piston member 206 coupled with the nut is transferred in the axial direction as shown in FIG. 15B, similar to the above. Similarly, the rotational movement of the screw shaft 202 in the reverse direction causes the nut 204 to be rotated in the same direction as the screw shaft 202. However, since the side surface 204k of the rectangular plate-shaped portion 204b, and the side surface 201f of the guide groove 201e, which face each other, come in contact with each other, the rotation of the nut 204 is prevented. Furthermore, since the side surface 204k is slid along the side surface 201f, the nut 204 moves in the axial direction thereof while being guided. In this case, the fluid in the cylinder portion 201b can be discharged from the fluid inlet 201c of the case 201 to the outside of the cylinder portion 201b. Accordingly, it is possible to operate the brake apparatus by connecting a wheel cylinder of the brake apparatus with the fluid inlet 201c.

According to the third embodiment, the nut 204 is integrally formed with the rectangular plate-shaped portion 204b, which extends outward in the radial direction and can be engaged with the guide groove 201e of the case 201. Accordingly, the rotation of the nut 204 is prevented by engaging the rectangular plate-shaped portion 204b with the guide groove 201e. Furthermore, since the rectangular plate-shaped portion 204b is accurately formed with respect to the nut 204, the relative positional relation between the rectangular plate-shaped portion 204b and the case 201 is defined with high accuracy. For this reason, it is possible to restrain from the operation fail. In addition, since the rectangular plate-shaped portion 204b is made of metal, similar to the nut 204, it is possible to secure the life span regardless of use conditions.

### Forth Embodiment

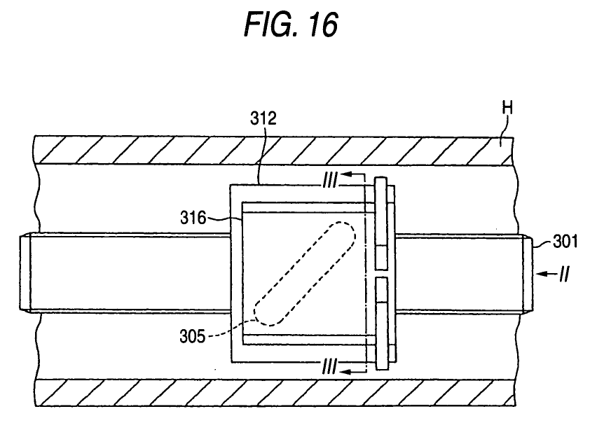

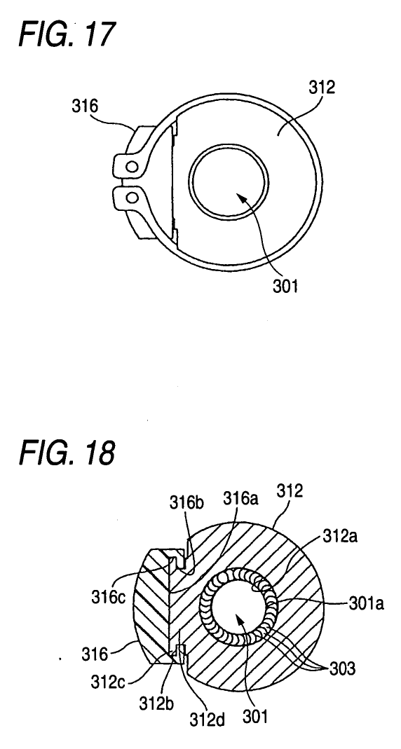

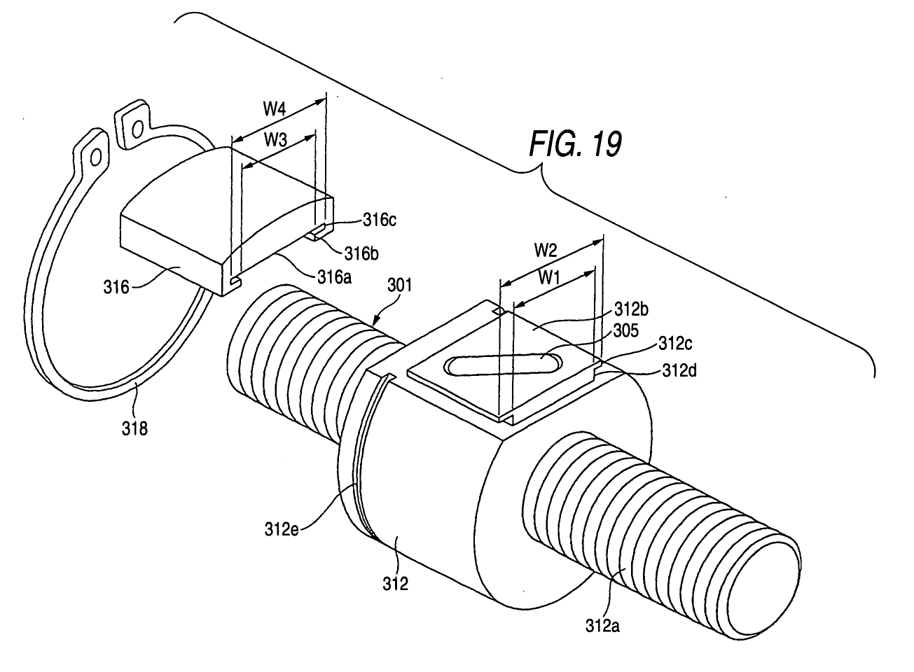

Hereinafter, preferred embodiments of the invention will be described with reference to accompanying drawings. FIG. 16 is a top view of a ball screw mechanism of a forth embodiment. In this drawing, a housing is not shown, and a screw shaft is schematically shown. FIG. 17 is a view showing a structure shown in FIG. 16 as seen in a direction indicated by an arrow II. FIG. 18 is a cross-sectional view taken along line III-III in FIG. 16 as seen in a direction indicated by arrows. FIG. 19 is an exploded perspective view showing the ball screw mechanism of the forth embodiment.

In FIG. 16, a screw shaft 301 is connected to a motor (not shown) and is supported so as to be axially immovable and only rotatable in a housing H. A male thread groove 301a is formed on an outer peripheral surface of the screw shaft 301. On the other hand, as shown in FIG. 18 a cylindrical nut 312 is supported so as to be only axially movable with respect to the housing H as described below. The nut 312 is disposed so as to surround the screw shaft 301 and has a female thread groove 312a on the inner peripheral surface thereof. A plurality of balls 303 is arranged so as to be able to roll within a spiral raceway formed between the thread grooves 301a and 312a facing each other. In addition, both ends of the nut 312 may be sealed by sealing members. The screw shaft 301, the nut 312 and the balls 303 form the ball screw mechanism.

As shown in FIGS. 18 and 19, a convex locking part 312b that is convexly formed in a T shape is formed on the periphery of the nut 312. More specifically, in the cross-sectional view shown in FIG. 18, the locking part 312b includes a narrow portion 312d having a first width W1, and a wide portion 312c that is positioned on the outside of the narrow portion 312d in the radial direction and has a second width W2. Meanwhile, a mounting member 316 has a locking groove 316a having a T shaped cross-section. More specifically, in the cross-sectional view shown in FIG. 18, the locking groove 316a includes a narrow portion 316b having a third width W3, and a wide portion 316c having a fourth width W4. When the locking groove 316a is engaged with the locking part 312b, the wide portion 316c is positioned on the outside of the narrow portion 316b in the radial direction. In this case, each of the widths satisfies the following relationship.
W1≦W3<W2≦W4

The locking groove 316a does not pierce the both ends of the mounting member 316, and one end of the locking groove 316a (left side in FIG. 19) is terminated on the inside of the locking groove.

Hereinafter, the operation of the forth embodiment will be described. When the screw shaft 301 is driven to be rotated by a motor (not shown), the rotational movement of the shaft is efficiently converted into the linear movement of the nut 312 in the axial direction by the balls 303 that roll within the raceway and circulates from one end of the raceway to the other end thereof through the tube 305 so that a driven member (not shown) coupled with the nut can be transferred in the axial direction.

When the mounting member 316 is assembled to the nut 312, as shown in FIG. 19, the mounting member 316 is positioned in the axial direction of the nut 312. After that, the mounting member 316 is slid so that the locking part 312b is engaged with the locking groove 316a and the locking part 312b reaches the end of the locking groove 316a. In this case, the narrow portions 312d and 316b are closely engaged with each other, and the wide portions 312c and 316c are closely engaged with each other. Even when the narrow portion 316b of the mounting member 316 is to be separated from the nut 312 in the radial direction, the narrow portion 316b of the mounting member 316 does not pass the wide portions 312c of the nut 312 due to the fact that the width W3 is narrower than the width W2. Accordingly, the both of the mounting member 316 and the nut 312 are not separated from each other. For this reason, the separation of the tube 305 from the nut is prevented without using the screws or the like. In the forth embodiment, the mounting member 316 may be made of a resin, or may be made of metal.

In addition, there is a possibility that the mounting member 316 is separated from the nut 312 in the axial direction. Therefore, in the forth embodiment, a retaining ring 318 is engaged with the peripheral groove 312e formed on the periphery of the nut 312 so as to prevent the separation of the mounting member 316. The retaining ring 318 may have a tapered cross-section to reduce a backlash in the axial direction.

### Fifth Embodiment

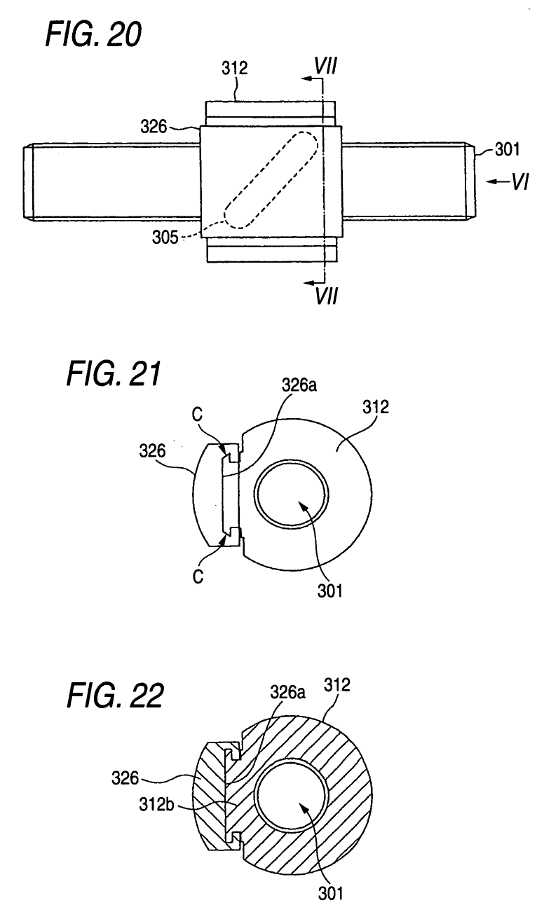

FIG. 20 is a top view of a ball screw mechanism of a fifth embodiment. In this drawing, a housing is not shown, and a screw shaft is schematically shown. FIG. 21 is a view showing a structure shown in FIG. 20 as seen in a direction indicated by an arrow VI. FIG. 22 is a cross-sectional view taken along line VII-VII in FIG. 20 as seen in a direction indicated by arrows.

A mounting member 326 of a fifth embodiment has a locking groove 326a that has the same shape as that of the forth embodiment, and is necessarily made of metal. Even in a fifth embodiment, when the mounting member 326 is slid, the locking groove 326a is engaged with the locking part 312b of the nut 312. Accordingly, the both of the mounting member and the nut are not separated from each other. For this reason, the separation of the tube 305 from the nut is prevented.

Furthermore, after the locking groove 326a of the mounting member 326 is engaged with the locking part 312b of the nut 312, one end of the opened locking groove 326a is caulked (C) as shown in FIG. 21. The separation of the mounting member 326 can be prevented by caulking (C) without the retaining ring or the like. The caulking (C) may be performed at any one end of the opened locking groove 326a. Since the other structure is the same as that of the above-mentioned forth embodiment, the description thereof is omitted.

### Sixth Embodiment

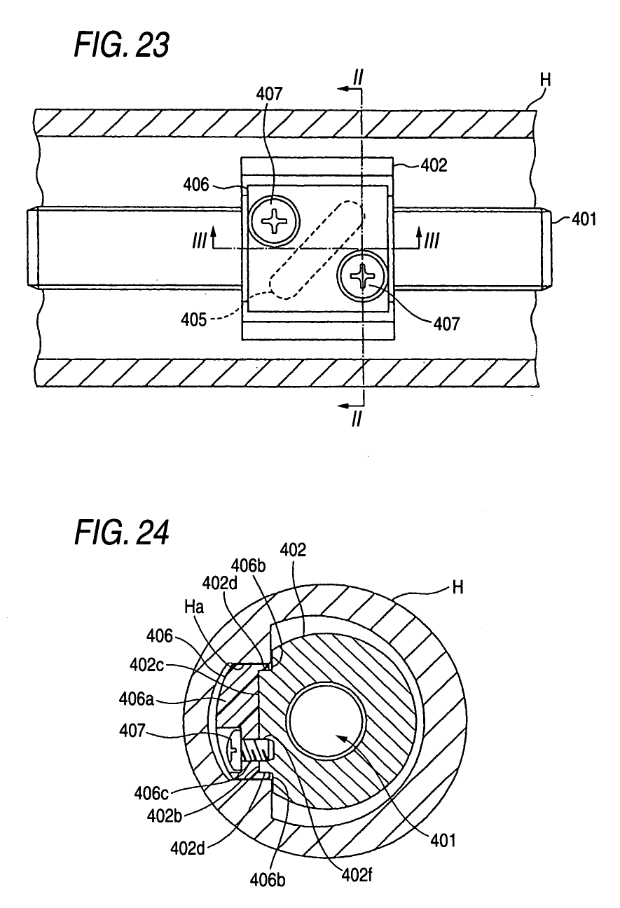

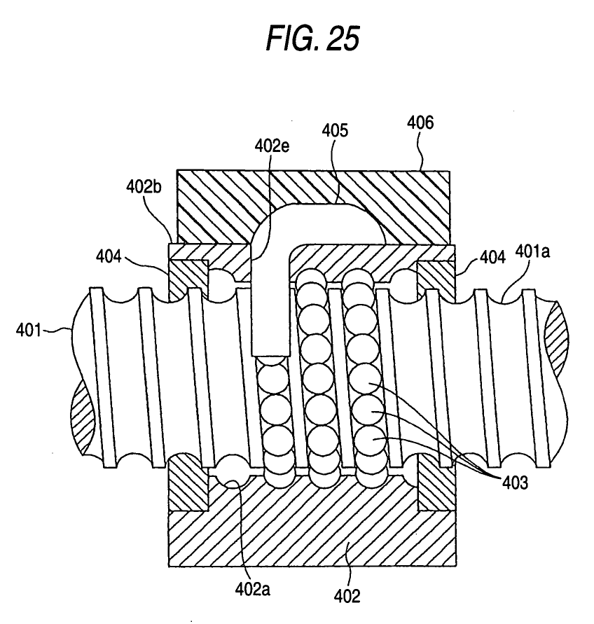

Hereinafter, preferred embodiments of the invention will be described with reference to accompanying drawings. FIG. 23 is a top view showing a ball screw mechanism of a sixth embodiment. In this drawing, a housing is shown in cross-section, and a screw shaft is schematically shown. FIG. 24 is a cross-sectional view taken along line II-II in FIG. 23 as seen in a direction indicated by arrows. FIG. 25 is a cross-sectional view taken along line III-III in FIG. 23 as seen in a direction indicated by arrows.

In FIG. 25, a screw shaft 401 is connected to a motor (not shown) and is supported so as to be axially immovable and only rotatable in a housing H (FIG. 23). A male thread groove 401a is formed on an outer peripheral surface of the screw shaft 401. On the other hand, a cylindrical nut 402 is supported so as to be only axially movable with respect to the housing H as described below. The nut 402 is disposed so as to surround the screw shaft 401 and has a female thread groove 402a on the inner peripheral surface thereof. A plurality of balls 403 are arranged so as to be able to roll within a spiral raceway formed between the thread grooves 401a and 402a facing each other. In addition, both ends of the nut 402 are sealed by sealing members 404. The screw shaft 401, the nut 402 and the balls 403 constitute the ball screw mechanism.

As shown in FIG. 24, a stepped portion 402b is formed on the periphery of the nut 402. The stepped portion 402b has a mounting surface 402c that extends along and parallel to an axis of the nut 402, and flange surfaces 402d (facing each other in a circumferential direction) that inwardly extend from both side edges (upper and lower-edges in FIG. 24) of the mounting surface 402c in a direction orthogonal to the mounting surface and in the axial direction.

The stepped portion 402b is provided with two circulating holes 402e (see FIG. 25) and two screw holes 402f (see FIG. 24). Both ends of a tube (a circulating member) 405 bent in the U shape are connected to the two circulating holes 402e, respectively. The tube 405 is used to return the balls 403 from one end of the spiral raceway, which is formed between the thread grooves 401a and 401b, to the other end thereof during the operation of the ball screw mechanism.

In order for the tube 405 not to be separated from the nut 402, a mounting member 406 is provided to cover the radial outside of the tube. As shown in FIG. 24, the mounting member 406 is formed so as to have a substantially U-shaped section corresponding to the stepped portion 402b, that is, includes a main body 406a corresponding to the mounting surface 402c, and flange portions 406b corresponding to the flange surfaces 402d, respectively. The mounting member further includes a through hole 406c. By mounting the mounting member to the stepped portion 402b so that the main body 406a of the mounting member 406 comes in contact with the mounting surface 402c and the flange portions 406b come in contact with the flange surfaces 402d, the tube 405 is retained from the radial outside. By inserting two screws 407 through the through hole 406c and screwing these screws into the screw holes 402f, respectively, in this state, the mounting member 406 is fixed to the nut 402.

In an assembled state, as shown in FIG. 24, the mounting member 406 is engaged with an axial groove Ha formed in the housing H. In this case, the flange portions 406b of the mounting member 406 are interposed between the flange surfaces 402d of the nut 402 and side surfaces of the axial groove Ha of the housing H.

Hereinafter, the operation of the present embodiment will be described. When the screw shaft 401 is driven to be rotated by a motor (not shown), the rotational movement of the shaft is efficiently converted into the linear movement of the nut 402 in the axial direction by the balls 403 that roll within the raceway and circulates from one end of the raceway to the other end thereof through the tube 405 so that a driven member (not shown) coupled with the nut can be transferred in the axial direction.

At this time, a rotational force is applied to the nut 402. In this case, the flange portions 406b of the mounting member 406 is interposed between the flange surfaces 402d of the nut 402 and the side surfaces of the axial groove Ha of the housing H. Thus, most of the force that the nut 402 receives from the side surfaces of the axial groove Ha is received by the flange surfaces 402d of the stepped portion 402b via the flange portions 406b. Accordingly, the rotation of the nut 402 is prevented. In other words, since the force received by the nut 402 from the side surfaces of the axial groove Ha is hardly transmitted to the screws 407, which stops the screws 407 from being loosened. In addition, if the mounting member 406 is made of a resin, it will have a buffer function. Therefore, generation of noises, etc. is suppressed. However, the mounting member may be made of metal.

Meanwhile, in a case where the mounting member 406 is made of relatively soft resin, when the mounting member is mounted to the nut 402 using the screws 407, a reaction force received by the screws 407 during fastening is weak. Thus, an operator will be apt to fasten the screws with a strong force. As a result, there is a fear that the mounting member 406 may be deformed or damaged. Also, if temperature management during assembly is not performed strictly, a difference in thermal expansion between the mounting member 406 and the screws 407 may be caused, which results in a reduction in a fastening force of the screws 407. The following embodiment can solve these problems.

### Seventh Embodiment

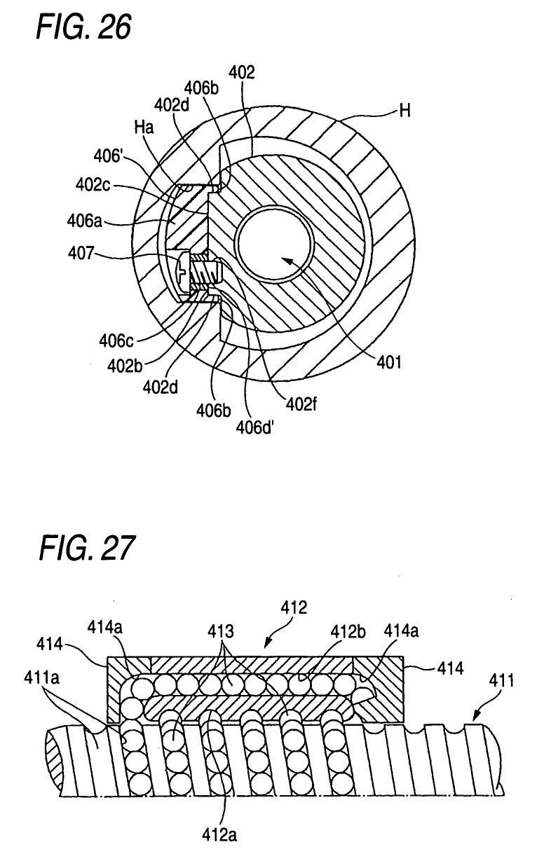

FIG. 26 is a cross-sectional view, similar to FIG. 24, of a ball screw mechanism according to a seventh embodiment. The present embodiment is different only in the structure of the mounting member from the embodiment shown in FIG. 24. More specifically, in a mounting member 406′ entirely made of a resin, metal barrels 406d′ are fitted into the through holes 406c. Since the other structure is the same as that in the above-described embodiment, the same elements as those in the above embodiment are denoted by the same reference numerals, and the description thereof will be omitted. The metal barrels 406d′ may be insert-molded into and formed integrally with the through holes 406c′ of the mounting member 406′, or may be integrated as a separate member by press-fitting, etc.

Preferably, each metal barrel 406d′ has a length slightly larger than a portion of the mounting member 406′ therearound. When the mounting member 406′ is mounted to the nut 402, the screws 407 are inserted into the metal barrels 406d′ and screwed into the screw holes 402f. At this time, since the metal barrels 406d′ are located around the screws 407 (between the heads of the screws 407 and the nut 402), and the metal barrels 406d′ having a higher stiffness than a resin member are interposed between the heads of the screws 407 and the nut 402 to generates a drag force, the operator can feel a fastening reaction force. This can keep an operator from excessively screwing the screws, thereby preventing the mounting member 406′ from being deformed or damaged. It is also possible to suppress occurrence of a difference in thermal expansion between the metal barrels 406′ and the screws 407 while the ball screw mechanism is used. As a result, the fastening force of the screws 407 can be prevented from being reduced.

### Eighth Embodiment

FIG. 27 is an axial cross-sectional view of a ball screw mechanism according to an eighth embodiment. In FIG. 27, a screw shaft 411 is connected to a motor (not shown) and is supported so as to be immovable axially and rotatable only within a housing (not shown). An outer peripheral surface of the screw shaft 401 is formed with a male thread groove 411a. On the other hand, a cylindrical nut 412 is supported so as to be movable axially only with respect to the housing H in a manner described below. The nut 412 is disposed so as to surround the screw shaft 411, and has a female thread groove 412a formed on the inner peripheral surface thereof and has four return passageways 412b (only one return passageway is shown) passing axially therethrough and opened to both ends of the nut 412. A plurality of balls 413 is arranged so as to be able to roll within a spiral raceway formed between both the thread grooves 411a and 412a facing each other. End caps 414 and 414 serving as circulating members are mounted to both ends of the nut 412. The end caps 414 and 414 have the same shape.

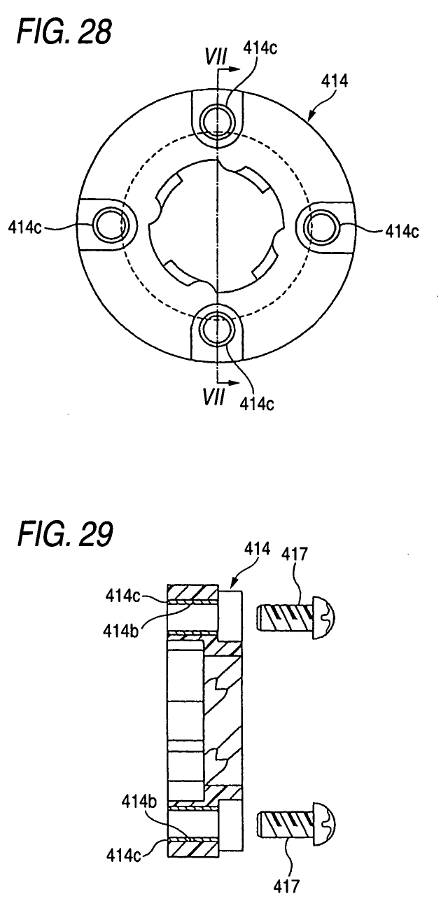

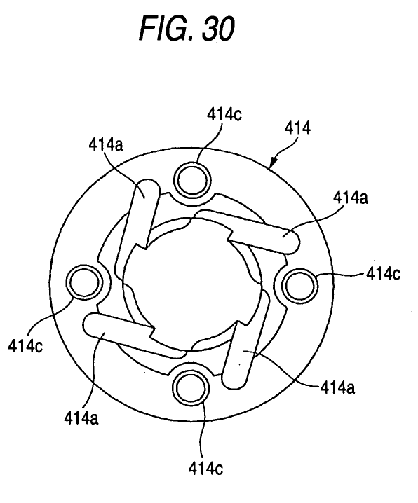

FIG. 28 is a view showing one end cap 414 as seen from the axial outside. FIG. 29 is a view when the end cap 414 of FIG. 28 is cut along a line VII-VII and seen in a direction indicated by arrows. FIG. 30 is a view showing the end cap 414 as seen from the axial inside. An inner surface (see FIG. 30) of the annular end cap 414 is provided with four scooping portions 414a, each having one end connected to the spiral raceway formed between both the thread grooves 411a and 412a and the other end connected to each return passageway 412b of the nut 412. In addition, the end cap 414 has four through holes 414b passing axially therethrough.

In the end cap 414 entirely made of a resin, metal barrels 414c are fitted into the through holes 414b. The metal barrels 414c may be insert-molded into and formed integrally with the through holes 414c of the end caps 414, or may be integrated as separate members by press-fitting, etc.

Now, the operation of the present embodiment will be described. When the screw shaft 411 is driven to rotate by a motor (not shown), the balls 403 roll within the raceway such that they are scooped up to the return passageways 412b by the scooping portions 414a of the one end cap 414, and they are returned to the raceway by the scooping portions 414a of the other end cap 414. This efficiently converts the rotational movement of the screw shaft 411 into axial movement of the nut 412, so that a driven member (not shown) connected to the shaft can be moved axially.

Preferably, each metal barrel 414c has a length slightly larger than that of a portion of the end cap 414 therearound. When the end cap 414 is mounted to the nut 412, the screws 417 (see FIG. 29) are inserted into the metal barrels 414c and screwed into the screw holes (not shown). At this time, although the metal barrels 414c are located around the screws 417 (between the heads of the screws 417 and the nut 412), the metal barrels 414c having a higher stiffness than a resin member lie between the heads of the screws 417 and the nut 412 to generates a drag force. Accordingly, the operator can feel a fastening reaction force. This can keep an operator from excessively screwing the screws 417, thereby preventing the end cap 414 from being deformed or damaged. It is also possible to suppress occurrence of a difference in thermal expansion between the metal barrels 414c and the screws 417 while the ball screw mechanism is used. As a result, the fastening force of the screws 417 can be prevented from being reduced.

In the embodiments described above, as the resin material for the mounting members 406, 406′ and the end caps 414, it is preferable to use a 6-6 nylon or a 4,6 nylon into which glass fibers of about 10 to 30% are mixed. However, the resin material is not limited thereto.

Although the invention is described hitherto with reference to the embodiments, the invention is not limited to the embodiments and can be appropriately modified and improved. For example, the circulating member is not limited to the tube, and may be a block. Specifically, when the block is used, the structure for aligning the mounting member with the assembly position may include, for example, a protrusion formed on the lower surface of the mounting member 11 and a recess serving as the cylindrical hole 4d to be engaged with the protrusion.

Further, for example, if the mounting member, which has a locking groove formed in the shape shown in FIGS. 16 to 22, is made of a resin material, the mounting member can be assembled to the nut without sliding the mounting member by modifying a width of the narrow portion of the locking groove so as to be wider than that of the wide portion of the locking part. In addition, the circulating member is not limited to the tube, and may be a block.

1. A ball screw mechanism comprising:
a housing that has a recess;
a screw shaft that have a male thread groove on an outer peripheral surface thereof;
a nut that is disposed so as to surround the screw shaft, has a female thread groove on an inner peripheral surface thereof, and has a cylindrical hole on an outer peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut,
wherein the mounting member has a cylindrical surface to be engaged with the cylindrical hole, and extends outward in a radial direction of the nut and can be engaged with the recess of the housing in a state in which the mounting member is assembled with the nut.

2. The ball screw mechanism according to claim 1, further comprising:
a member that aligns the mounting member with an assembly position when the mounting member is engaged with the cylindrical hole.

3. A ball screw mechanism comprising:
a housing that has a recess;
a screw shaft that have a male thread groove on an outer peripheral surface thereof;
a nut that is disposed so as to surround the screw shaft, and has a female thread groove on an inner peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut,
wherein the mounting member includes a first engaging part that extends outward in a radial direction of the nut and can be engaged with one side surface of the recess of the housing, and a second engaging part that can be engaged with the other side surface of the recess of the housing, and the first engaging part and the second engaging part are mounted to the nut so as to move relative to the nut.

4. The ball screw mechanism according to claim 3, wherein the first engaging part and the second engaging part are mounted to the nut so that the circulating member is interposed therebetween.

5. The ball screw mechanism according to claim 3, wherein
the first engaging part and the second engaging part are mounted to the nut by means of screws, and are caulked in the vicinity of the screws after being mounted.

6. A ball screw mechanism comprising:
a housing that has a recess;
a screw shaft that have a male thread groove on an outer peripheral surface thereof;
a nut that is disposed so as to surround the screw shaft, and has a female thread groove on an inner peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut, wherein
the nut is integrally formed with an engaging portion, which extends outward in a radial direction and can be engaged with the recess of the housing.

7. The ball screw mechanism according to claim 6, wherein
the engaging portion has a pair of engaging surfaces facing each other in a circumferential direction of the nut, and a predetermined gap is formed between at least one of the engaging surfaces and a guide surface of the recess of the housing.

8. The ball screw mechanism according to claim 6, further comprising:
a buffer member that buffers collision occurring between the nut relatively moving in an axial direction and the housing.

9. A ball screw mechanism comprising:
a housing;
a screw shaft that have a male thread groove on an outer peripheral surface thereof;
a nut that is disposed so as to surround the screw shaft, and has a female thread groove on an inner peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut, wherein
the nut has a locking part, which includes a narrow portion having a first width W1 and a wide portion that is positioned on the outside of the narrow portion in the radial direction and has a second width W2 in a cross-section orthogonal to an axis of the nut, on the periphery of the nut,
the mounting member has a locking groove, which includes a narrow portion having a third width W3 and a wide portion that is positioned on the outside of the narrow portion in the radial direction and has a fourth width W4 in a cross-section orthogonal to an axis of the mounting member, in a state in which the mounting member is mounted to the nut, and
the mounting member is mounted to the nut by the engagement between the locking part and the locking groove, and an expression W1≦W3<W2≦W4 is satisfied.

10. The ball screw mechanism according to claim 9,
wherein movement of the mounting member relative to the nut in an axial direction is limited by a fastener.

11. The ball screw mechanism according to claim 9,
wherein movement of the mounting member relative to the nut in an axial direction is limited by caulking.

12. A ball screw mechanism comprising:
a housing;
a screw shaft that have a male thread groove on an outer peripheral surface thereof;
a nut that is disposed so as to surround the screw shaft, and has a female thread groove on an inner peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut,
wherein a periphery of the nut is formed with flange surfaces facing each other in a circumferential direction, and at least a portion of the mounting member is disposed between the housing and the flange surfaces.

13. The ball screw mechanism according to claim 12, wherein
the mounting member is mounted to the nut by screws.

14. The ball screw mechanism according to claim 13, wherein
the mounting member is made of a resin in which metal barrels are disposed around at least the screws.

15. A ball screw mechanism comprising:
a housing;
a screw shaft that have a male thread groove on an outer peripheral surface thereof;
a nut that is disposed so as to surround the screw shaft, and has a female thread groove on an inner peripheral surface thereof;
a plurality of balls that is disposed so as to roll along a raceway formed between the thread grooves facing each other;
a circulating member that is mounted to the nut so as to return the balls from one end of the raceway to the other end thereof; and
a mounting member that fixes the circulating member to the nut,
wherein the circulating member is made of a resin in which metal barrels are disposed around at least the screws.

16. The ball screw mechanism according to claim 4, wherein
the first engaging part and the second engaging part are mounted to the nut by means of screws, and are caulked in the vicinity of the screws after being mounted.

17. The ball screw mechanism according to claim 7, further comprising:
a buffer member that buffers collision occurring between the nut relatively moving in an axial direction and the housing.
